(19) United States
(12) Patent Application Publication
(10) Pub. No.: US 2023/0374925 A1
(43) Pub. Date: Nov. 23, 2023

(54) HEATING CARRIER, AND EXHAUST GAS REDUCTION CARRIER HAVING HEATING CARRIER

(71) Applicant: KOREA RESEARCH INSTITUTE OF CHEMICAL TECHNOLOGY, Daejeon (KR)

(72) Inventors: Sang Joon KIM, Daejeon (KR); Jin Hee LEE, Daejeon (KR); Young Jin KIM, Daejeon (KR); Tae Sun CHANG, Daejeon (KR); Young Woo YOU, Daejeon (KR); Soo Min KIM, Daejeon (KR); Il Jeong HEO, Daejeon (KR)

(21) Appl. No.: 18/031,136

(22) PCT Filed: Oct. 8, 2021
(86) PCT No.: PCT/KR2021/013841

§ 371 Date: Apr. 10, 2023

(30) Foreign Application Priority Data
Oct. 8, 2020 (KR) 10-2020-0129783

(51) Int. Cl. F01N 3/20; F01N 3/28; B01J 35/04; B01J 35/00; B01J 23/40; B01J 29/072; B01J 23/30; B01D 53/94

(52) U.S. Cl. CPC F01N 3/2026; F01N 3/2828; B01J 35/04; B01J 35/0033; B01J 35/0006; B01J 23/40; B01J 29/072; B01J 23/30; B01D 53/9413; F01N 2370/04; F01N 2330/06; F01N 2330/30; F01N 2510/068; B01D 2255/1021; B01D 2255/1023; B01D 2255/1025; B01D 2255/1028; B01D 2255/1026; B01D 2255/50; B01D 2255/20761; B01D 2255/20738; B01D 2255/20723; B01D 2255/20776; B01D 2255/9155; B01D 2258/01; B01D 2257/404; B01D 2257/502; B01D 2257/702

(57) ABSTRACT

An object of the present invention is to provide a heating carrier that does not heat all of exhaust gas flowing into a catalyst converter, but directly supplies, to a catalyst layer, thermal energy in the form of an instantaneous pulse to effectively activate a catalyst during a cold start-up period, and thus may reduce emission pollutants with a small amount of energy, and an exhaust gas reduction carrier having the heating carrier. In order to accomplish the object, the heating carrier of the present invention may include a main body of which the inside is formed to have a honeycomb structure, the main body being formed of a conductive ceramic material that is a nonmetallic heating element; and a catalyst layer formed by coating a first catalyst on a surface of the main body.

### TECHNICAL FIELD

The present invention relates to a heating carrier, and more particularly, to a heating carrier that may reduce exhaust pollutants generated during cold start-up of a power system when an internal or external combustion engine is started in a cold state, and an exhaust gas reduction carrier having the heating carrier.

### BACKGROUND ART

Air pollutants such as fine dust, greenhouse gases, and odors are major factors that threaten the health of people to the extent of being selected as the number one factor that threatens health, and are recognized as a serious national disaster. In particular, it is known that most of the secondary fine dust (PM 2.5 or less) classified as ultrafine dust is generated by chemical reactions of pollutants such as nitrogen oxides (NOx), volatile organic compounds (VOC), and sulfur oxides (SOx) in the air.

Therefore, these gaseous air pollutants may be reversely removed through a chemical reaction through a catalyst. In a case of a permanent establishment, pollutants have been reduced through a regenerative catalytic oxidizer (RCO), and in a case of a mobile (automobile, bus, or the like), emission pollutants have been effectively reduced through a catalyst such as a diesel oxidation catalyst (DOC), a three-way catalyst (TWC), or a selective catalytic reduction (SCR). However, a catalyst that may reduce air pollutants by inducing a chemical reaction with the air pollutants is activated only when energy (heat) of about 200 to 300° C. is supplied. Since there is no heat source that may activate the catalyst during a cold start-up period when an internal or external combustion engine is started in a cold state to drive a power system, most of the pollutants are discharged without being reduced or converted. In particular, the problem of the pollutants being emitted during such a cold start-up period is noticeable in mobiles that are frequently turned off and on.

Referring to Korean Patent Laid-Open Publication No. 10-2002-0052352, as illustrated in FIG. 1, in a catalyst of an exhaust gas purification apparatus used to purify exhaust gas generated from an automobile engine according to the related art, a catalyst light-off time improvement apparatus includes an electric heater 5 installed in an exhaust pipe 3 connected to an upstream shaft of a catalyst converter 1 and may actively operate the electric heater to heat the exhaust gas when an engine is started in a cold state.

However, a technology of heating exhaust gas using the electric heater according to the related art requires a lot of energy because a temperature of a considerable amount of exhaust gas (most unnecessary air that does not need to be heated) discharged from the engine should be increased to 200° C. or higher, which causes a problem in that the fuel efficiency of the automobile is reduced by that much.

### RELATED ART DOCUMENT

### Patent Document

Korean Patent Laid-Open Publication No. 10-2002-0052352 (published on Jul. 4, 2002)

### DISCLOSURE

### Technical Problem

The present invention has been made to solve the above problem, and an object of the present invention is to provide a heating carrier that does not heat all of exhaust gas flowing into a catalyst converter, but directly supplies, to a catalyst layer, thermal energy in the form of an instantaneous pulse to effectively activate a catalyst during a cold start-up period, and thus may reduce emission pollutants with a small amount of energy, and an exhaust gas reduction carrier having the heating carrier.

### Technical Solution

In one general aspect, a heating carrier includes a main body of which the inside is formed to have a honeycomb structure, the main body being formed of a conductive ceramic material that is a nonmetallic heating element; and a catalyst layer formed by coating a first catalyst on a surface of the main body.

Furthermore, the main body may be formed of silicon carbide (SiC) that is a carbide-based material or a carbide-based material (Ti₃SiC₂ or Ti₃AlC₂) forming MAX phases, and may be formed of any one of conductive ceramics composed of molybdenum disilicide (MoSi₂), lanthanum chromite (LaCrO₂), and zirconia.

Furthermore, the first catalyst may be formed of a mixture of an oxide supported with one or more metals of platinum (Pt), palladium (Pd), rhodium (Rh), iridium (Ir), and ruthenium (Ru) and an oxide containing zeolite supported with copper (Cu) and iron (Fe), a vanadium oxide, and a tungsten oxide, and the first catalyst may be supported on an inner circumferential surface and an outer circumferential surface of the main body to form the catalyst layer.

Furthermore, the heating carrier according to the present invention may further include an electrode body wound around each of one end and the other end of the main body in a length direction and receiving power from the outside.

In this case, the heating carrier according to the present invention may further include a conductive paste coated on a point where a surface of the heating carrier is in contact with the electrode body so as to reduce contact resistance with the electrode body.

In addition, the conductive paste may contain a high-temperature paste formed of one or two or more pastes selected from a carbon paste containing silicate, a silver (Ag) paste, platinum (Pt), palladium (Pd), and indium tin oxide (ITO) pastes, an aluminum-doped zinc oxide (AZO) paste, a silicon carbide (SiC) paste, and a carbon paste.

In another general aspect, an exhaust gas reduction carrier having a heating carrier includes a catalyst carrier installed in an accommodation space for a catalyst converter; and a heating carrier including a main body of which the inside is formed to have a honeycomb structure, the main body being formed of a conductive ceramic material that is a nonmetallic heating element, and a catalyst layer formed by coating a first catalyst on a surface of the main body.

Furthermore, the heating carrier may be inserted into the catalyst carrier and may have a diameter of 10% to 90% of a diameter of the catalyst carrier.

Furthermore, the heating carrier may be inserted into the catalyst carrier and may have a length of 10% to 90% of a length of the catalyst carrier.

Furthermore, the heating carrier may be inserted into the catalyst carrier to be concentric with the catalyst carrier, may be formed to have a length longer than a length of the catalyst carrier, and may penetrate through the catalyst carrier.

In this case, the heating carrier may further include an electrode body wound around each of one end and the other end of the main body in a length direction.

In addition, the heating carrier may further include a conductive paste coated on a surface of the electrode body and a point where the surface of the main body is in contact with the electrode body.

Furthermore, the heating carrier may include a center carrier inserted into the center of the catalyst carrier to be concentric with the catalyst carrier; and three or more peripheral carriers radially formed around the center carrier.

### Advantageous Effects

The heating carrier and the exhaust gas reduction carrier having the heating carrier according to the present invention may effectively supply a heat source to the catalyst layer coated on the main body through the above configuration without increasing a temperature of exhaust gas itself flowing into the heating carrier. In addition, the inside of the main body has the honeycomb structure, such that the catalyst layer formed on the outer surface as well as the inner surface may be evenly heated, and an action of the heated catalyst may actively occur on the exhaust gas passing through the inside of the main body.

### DESCRIPTION OF DRAWINGS

FIG. 1 illustrates an exhaust gas purification apparatus according to the related art.

FIG. 2 is a perspective view of connection of external power to a heating carrier according to the present invention.

FIG. 3 is a side view of the heating carrier according to the present invention.

FIG. 4 is a schematic perspective view of connection of the heating carrier and an exhaust gas reduction carrier having the heating carrier according to the present invention.

FIG. 5 is a perspective view of a heating carrier and an exhaust gas reduction carrier having the heating carrier according to a first embodiment of the present invention.

FIG. 6 is a side view of the heating carrier and the exhaust gas reduction carrier having the heating carrier according to the first embodiment of the present invention.

FIG. 7 is a side view of a heating carrier and an exhaust gas reduction carrier having the heating carrier according to a second embodiment of the present invention.

FIG. 8 is a front view of a heating carrier and an exhaust gas reduction carrier having the heating carrier according to a fourth embodiment of the present invention.

FIG. 9 is a schematic view of a heating test for a main body according to the present invention.

FIG. 10 is a photograph of the heating test for the main body according to the present invention.

FIG. 11 is a graph of the heating test for the main body according to the present invention.

FIG. 12 is a graph of a safety test for the main body according to the present invention.

FIG. 13 is a comparative photograph showing before and after catalyst coating of the main body according to the present invention.

FIG. 14 is a graph showing a reduction in CO passing through a catalyst layer.

FIG. 15 is a graph showing a reduction in HC passing through the catalyst layer.

FIG. 16 is a graph showing a reduction in NO passing through the catalyst layer.

FIG. 17 is a graph showing a reduction characteristic of NO passing through the catalyst layer at the beginning and after 22 hours.

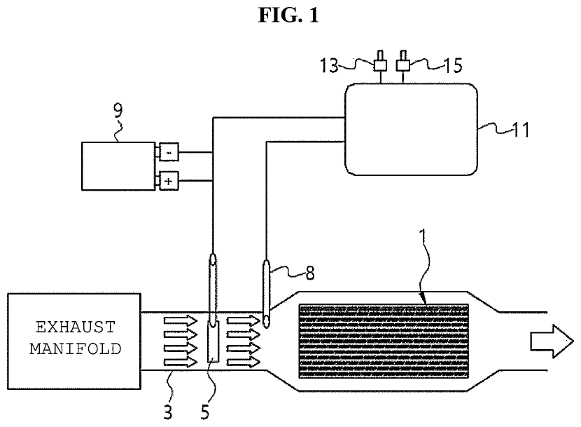

### BEST MODE

Hereinafter, the technical spirit of the present invention will be described in more detail with reference to the accompanying drawings. Terms and words used in the present specification and claims are not to be construed as general or dictionary meanings, but are to be construed as meanings and concepts meeting the technical spirit of the present invention based on a principle that the present inventors may appropriately define the concepts of terms in order to describe their inventions in the best mode.

Therefore, configurations described in the embodiments and drawings of the present invention do not represent all of the technical spirits of the present invention, but are merely the most preferable embodiments. Therefore, the present invention should be understood to cover various modifications that may replace the embodiments at the time of filing the present application.

Hereinafter, the technical spirit of the present invention will be described in more detail with reference to the accompanying drawings. The accompanying drawings are only examples illustrated in order to describe the technical spirit of the present invention in more detail. Therefore, the technical spirit of the present invention is not limited to forms of the accompanying drawings.

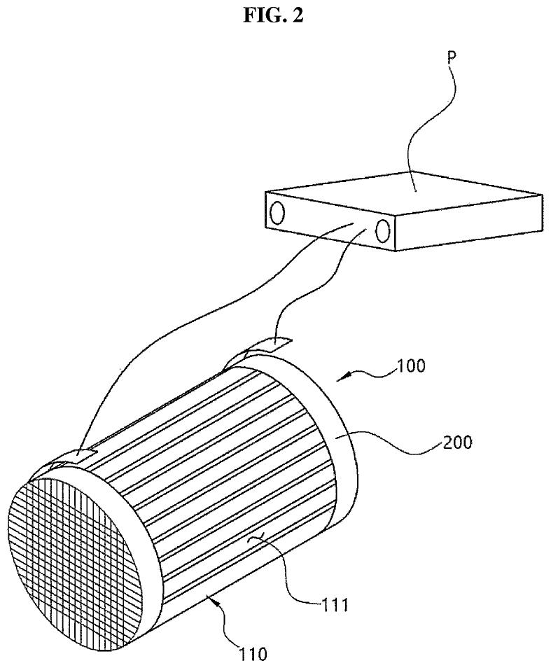

Referring to FIG. 2, a heating carrier 100 according to the present invention may include a main body 110 of which the inside is formed to have a honeycomb structure, the main body 110 being formed of a conductive ceramic material that is a nonmetallic heating element; and a catalyst layer 111 formed by coating a first catalyst on a surface of the main body.

The main body 110 is a nonmetallic heating element, is formed of a conductive material among ceramic materials, and has a honeycomb structure with a cylindrical shape. The catalyst layer 111 is formed by coating the first catalyst on an inner circumferential surface and an outer circumferential surface of the main body 110.

The heating carrier 100 according to the present invention may effectively supply a heat source to the catalyst layer 111 coated on the main body 110 through the above configuration without increasing a temperature of exhaust gas itself flowing into the heating carrier 100. In addition, the inside of the main body 110 has the honeycomb structure, such that the catalyst layer 111 formed on the outer surface as well as the inner surface may be evenly heated, and an action of the heated catalyst may actively occur on the exhaust gas passing through the inside of the main body 110.

In this case, the main body 110 may be formed of silicon carbide (SiC) that is a carbide-based material or a carbide-based material (Ti₃SiC₂ or Ti₃AlC₂) forming MAX phases, and may be formed of any one of conductive ceramics composed of molybdenum disilicide (MoSi₂), lanthanum chromite (LaCrO₂), and zirconia.

Silicon carbide (SiC) is one of the conductive ceramic materials that is a nonmetallic heating element, and has advantages such as a low coefficient of expansion, low deformation, chemical stability, a long lifespan, and easy installation and maintenance.

In addition, the first catalyst may be formed of a mixture of an oxide supported with one or more metals of platinum (Pt), palladium (Pd), rhodium (Rh), iridium (Ir), and ruthenium (Ru) and an oxide containing zeolite supported with copper (Cu) and iron (Fe), a vanadium oxide, and a tungsten oxide, and the first catalyst may be supported on an inner circumferential surface and an outer circumferential surface of the main body to form the catalyst layer.

In this case, a ratio of palladium (Pd) to rhodium (Rd) was set to 10:1, which was a composition of a commercial ternary catalyst, and a weight ratio of aluminum oxide (Al₂O₃) to palladium (Pd)/rhodium (Rd) serving as supports was set to 1.5 wt %. A weight ratio of the mixture of palladium (Pd), rhodium (Pd), and aluminum oxide (Al₂O₃) to water as a solvent was set to about 1:4, and stirring was performed for more than one day to prepare a coating slurry. In order to improve adhesion with the main body 110, aluminum hydroxide sol was added at a ratio of 1 wt % with respect to the total slurry.

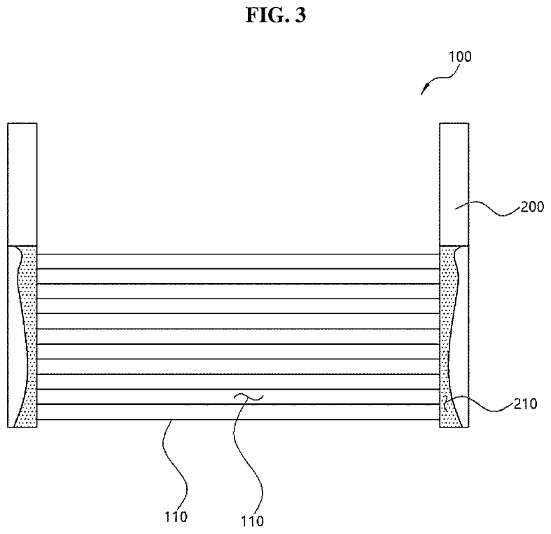

Referring to FIGS. 2 and 3, the heating carrier 100 according to the present invention may further include an electrode body 200 wound around each of one end and the other end of the main body 110 in a length direction and receiving power P from the outside.

The electrode body 200 is formed of a metal material such as stainless steel, is configured to be wound around each of one end and the other end of the main body 110 in the length direction, and receives the power P from the outside and supplies the power P to the main body 110, such that the main body 110 and the catalyst layer may be heated.

Referring to FIG. 3, the heating carrier 100 according to the present invention may further include a conductive paste 210 coated on a surface of the electrode body 200 and a point where the surface of the main body 110 is in contact with the electrode body 200.

The conductive paste 210 allows the electrode body 200 to closely adhere to the main body 110 so as to solve a problem of contact resistance formed between the electrode body 200 and the main body 110, such that heating efficiency of the main body 110 may be increased.

In this case, the conductive paste 210 may contain a high-temperature paste formed of one or two or more pastes selected from a carbon paste containing silicate, a silver (Ag) paste, platinum (Pt), palladium (Pd), and indium tin oxide (ITO) pastes, an aluminum-doped zinc oxide (AZO) paste, a silicon carbide (SiC) paste, and a carbon paste.

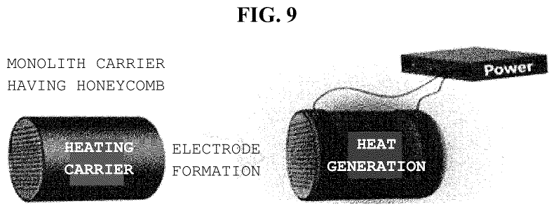

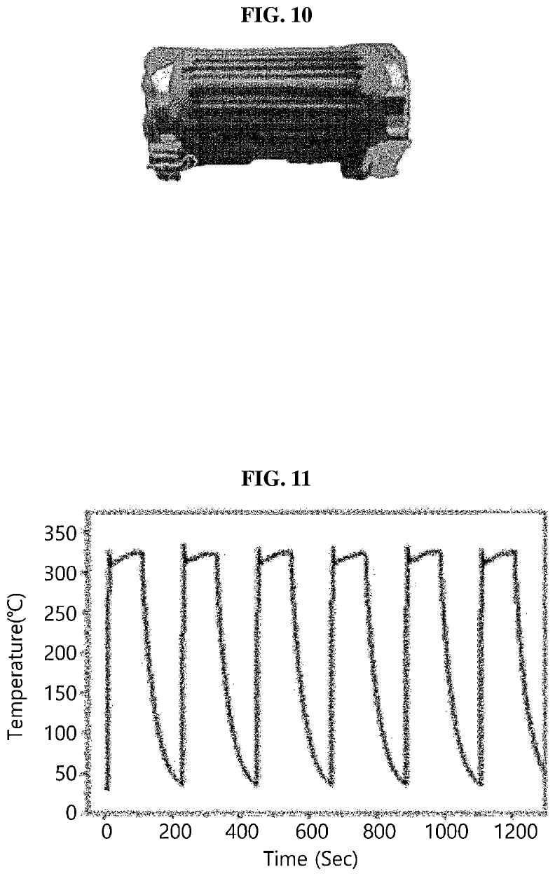

The heating carrier according to the present invention will be described in more detail. From a result of a heating test in which a voltage was lowered by connecting the electrode body to the main body, as illustrated in FIGS. 9 to 11, it was confirmed that a technology for securing contact resistance and safety of the electrode body was established, and thus a heating characteristic (cycling) was maintained.

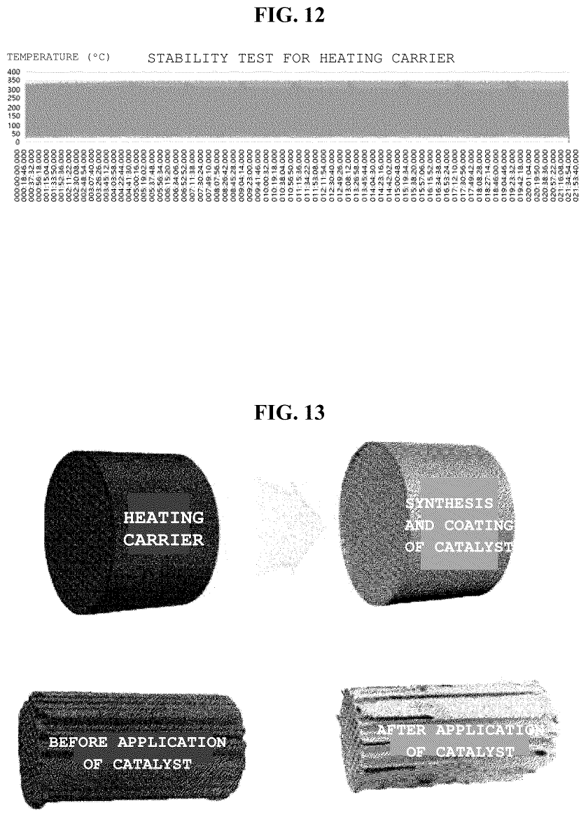

In addition, as illustrated in FIG. 12, as a result of confirming the most important pulse heating characteristic, the main body has generated heat of 200° C. or higher per second. The main body was maintained at 300° C. for 1 to 2 minutes, which was a cold start-up period of a mobile, and thus the heating carrier capable of activating the first catalyst according to the present invention was implemented.

Referring to FIG. 13, the first catalyst of the present invention was applied to the main body after increasing an adhesive force thereof when coated on the main body. A difficulty in coating the catalyst layer on the main body is an adhesive force between the main body and the catalyst layer. The first catalyst layer should be stable without delamination from the main body under significantly severe conditions in which rapid heating is performed at a temperature of 200° C. or higher per second. Therefore, in the heating carrier according to the present invention, in order to prevent the delamination of the catalyst layer from the main body, an adhesive (binder), a catalyst support, a solvent, firing conditions, and the like were studied to implement conditions in which the catalyst layer was stable even in hundreds of heating situations.

In addition, an ability of purifying exhaust gas of a cold start-up period simulation type mobile was evaluated by applying the technology of the main body and the coating layer coated on the main body. A performance test for the exhaust gas was conducted by simulating the same composition (NOx: 500 ppm, HC: 500 ppm, O₂: 0.85%, CO:1%, CO₂: 10%, H₂O: 0%) and amount of exhaust gas emitted (GHSV=100,000 h−1) from a gasoline vehicle during the cold start-up. The simulated exhaust gas was injected into the heating carrier developed for cold start-up, and a degree of purification was evaluated by instantly increasing the heat.

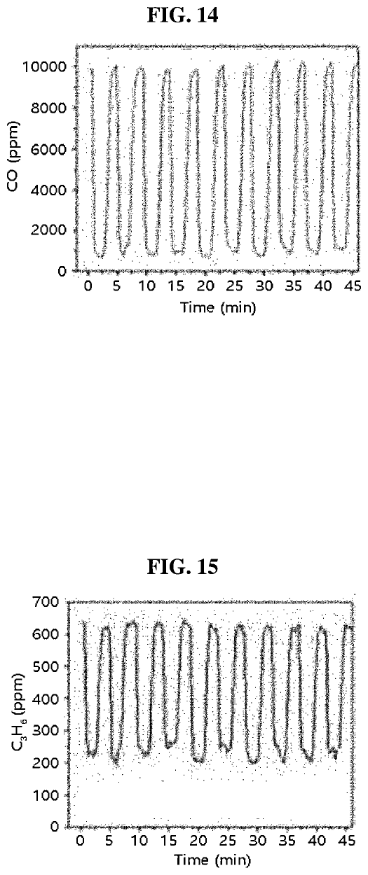

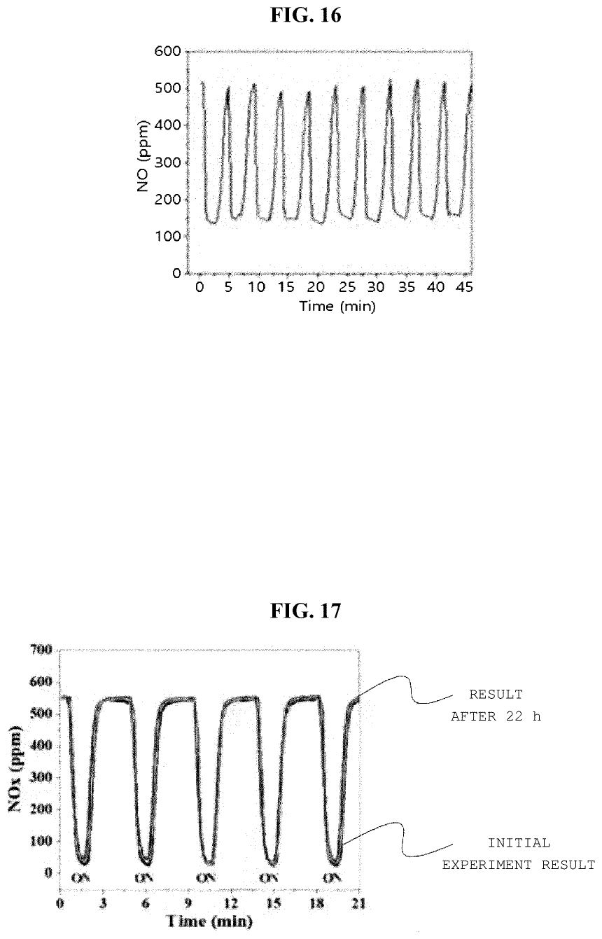

Referring to FIGS. 14 to 16, it was confirmed that NOx gas having an initial concentration of 550 ppm was instantly reduced by 95% or more to 29 ppm while passing through the catalyst layer where heat was generated, and CO was also removed by 91% or more. In the case of the gasoline vehicle, a cold start-up period is about 1 minute. In this evaluation experiment, NOx as the main culprit of ultrafine dust was reduced by 90% or more for 1 minute, and other harmful emissions such as CO and HC were also reduced by about 80 to 90%.

Referring to FIGS. 15 and 17, the stability against catalyst deterioration according to the heating characteristic of the main body and the coating layer coated on the main body was also confirmed. When the performance was confirmed after 400 or more cycles (on-off) of heating at 300° C. while injecting the simulated gas for 22 hours, it was confirmed that the reduction characteristic of NOx was the same as that of the initial experiment result. This indicates the result that the application of the conductive paste and the catalyst coating method for reducing the contact resistance between the main body and the electrode body presented in the present embodiment were effective.

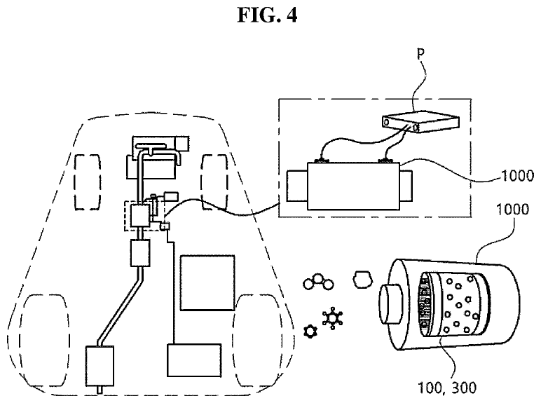

Referring to FIGS. 4 and 5, an exhaust gas reduction carrier having the heating carrier 100 according to the present invention may include a catalyst carrier 300 installed in an accommodation space for a catalyst converter 1000; and a heating carrier 100 including a main body of which the inside is formed to have a honeycomb structure, the main body being formed of a conductive ceramic material that is a nonmetallic heating element, and a catalyst layer formed by coating a first catalyst on a surface of the main body.

In general, as the catalyst carrier 300, a carrier inserted into the exhaust gas reduction catalyst converter 1000 may be applied, and as an example, a cordierite monolith catalyst may be applied.

In this case, the main body of the heating carrier 100 may be formed of silicon carbide (SiC). The heating carrier 100 is easily inserted into the catalyst carrier 300 because it is easily processed. The inserted heating carrier 100 may have an effect of reducing pollutants in the exhaust gas by heat generated by the coated catalyst layer itself, and may be used as a heat source for activating the catalyst of the catalyst carrier 300.

In this case, the heating carrier 100 may be inserted into the catalyst carrier 300, and may have a diameter of 10% to 90% of a diameter of the catalyst carrier 300.

The heating carrier 100 may be inserted into the catalyst carrier 300 to be concentric with the catalyst carrier 300, and may have the center different from that of the catalyst carrier 300.

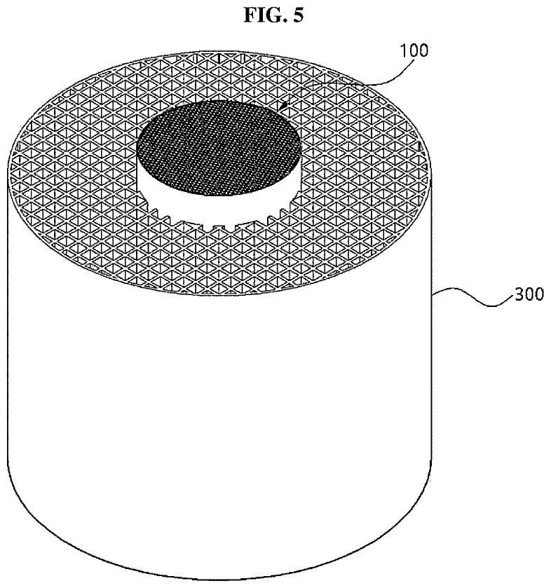

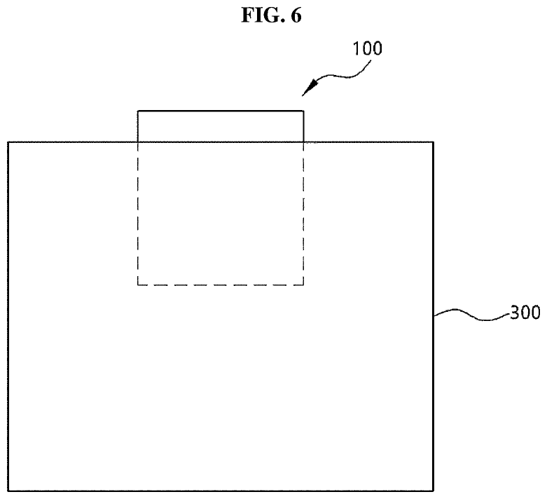

Referring to FIG. 6, the heating carrier 100 may be inserted into the catalyst carrier 300, and may have a length of 10% to 90% of a length of the catalyst carrier 300.

That is, as illustrated in FIG. 6, the heating carrier 100 may have a length of 10% to 90% of the length of the catalyst carrier 300, and may be inserted into and fixed to a portion of the catalyst carrier 300 in a length direction.

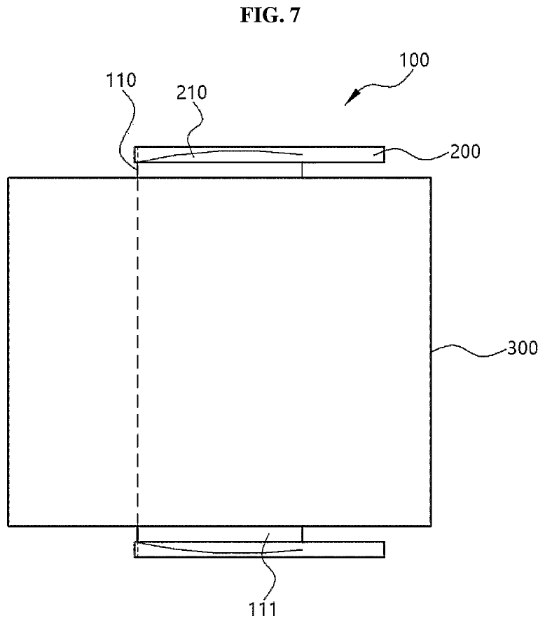

Referring to FIG. 7, the heating carrier 100 may be inserted into the center of the catalyst carrier 300 to be concentric with the catalyst carrier 300, may have a length longer than the length of the catalyst carrier 300, and may penetrate through the catalyst carrier 300.

That is, as illustrated in FIG. 7, the heating carrier 100 may have a length longer than the length of the catalyst carrier 300, and may be inserted into and fixed while penetrating the catalyst carrier 300 in the length direction.

In this case, the heating carrier 100 may further include an electrode body 200 wound around each of one end and the other end of the main body 110 in the length direction.

The electrode body 200 is formed of a metal material such as stainless steel, is configured to be wound around each of one end and the other end of the main body 110 in the length direction, and receives power from the outside and supplies the power to the main body 110, such that the main body 110, the catalyst layer, and the catalyst carrier 300 may be heated.

In addition, the heating carrier 100 may further include a conductive paste 210 coated on a surface of the electrode body 200 and a point where the surface of the main body 110 is in contact with the electrode body 200.

The conductive paste 210 may be applied over the electrode body 200, the main body 110 on which the catalyst layer is formed, and the catalyst carrier 300.

The conductive paste 210 allows the electrode body 200 to closely adhere to the main body 110 so as to solve a problem of contact resistance formed between the electrode body 200, and the main body 110 and the catalyst layer, such that heating efficiency of the main body 110 may be increased.

In this case, the conductive paste 210 may be formed of any one of a high-temperature carbon paste containing silicate, a silver (Ag) paste, and a paste formed of a mixture of a high-temperature carbon paste containing silicate and a silver (Ag) paste.

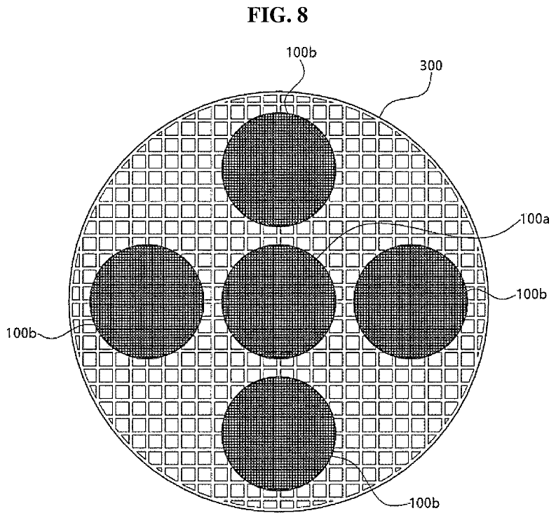

Referring to FIG. 8, the heating carrier 100 may include a center carrier 100a inserted into the center of the catalyst carrier 300 to be concentric with the catalyst carrier 300; and three or more peripheral carriers 100b radially formed around the center carrier 100a.

A plurality of heating carriers 100 may be inserted into the catalyst carrier 300. The heating carrier 100 may include the center carrier 100a inserted into the center of the catalyst carrier 300 in a width direction and the peripheral carriers 100b radially arranged around the center carrier 100a so that the heat of the heating carrier 100 is evenly distributed to the catalyst carrier 300.

The present invention is not limited to the embodiments described above, but may be variously applied, and may be variously modified without departing from the gist of the present invention claimed in the claims.

[Detailed Description of Main Elements]

| | |
|---|---|
| P: Power | 1000: Catalyst converter |
| 100: Heating carrier | 100a: Center carrier |
| 100b: Peripheral carrier | |
| 110: Main body | |
| 111: Catalyst layer | |
| 200: Electrode body | 210: Conductive paste |
| 300: Catalyst carrier | |

1. A heating carrier comprising:
a main body of which the inside is formed to have a honeycomb structure, the main body being formed of a conductive ceramic material that is a nonmetallic heating element; and
a catalyst layer formed by coating a first catalyst on a surface of the main body.

2. The heating carrier of claim 1, wherein the main body is formed of silicon carbide (SiC) that is a carbide-based material or a carbide-based material (Ti₃SiC₂ or Ti₃AlC₂) forming MAX phases, and is formed of any one of conductive ceramics composed of molybdenum disilicide (MoSi₂), lanthanum chromite (LaCrO₂), and zirconia.

3. The heating carrier of claim 1, wherein the first catalyst is formed of a mixture of an oxide supported with one or more metals of platinum (Pt), palladium (Pd), rhodium (Rh), iridium (Ir), and ruthenium (Ru) and an oxide containing zeolite supported with copper (Cu) and iron (Fe), a vanadium oxide, and a tungsten oxide, and the first catalyst is supported on an inner circumferential surface and an outer circumferential surface of the main body to form the catalyst layer.

4. The heating carrier of claim 1, further comprising an electrode body wound around each of one end and the other end of the main body in a length direction and receiving power from the outside.

5. The heating carrier of claim 4, further comprising a conductive paste coated on a surface of the electrode body and a point where the surface of the main body is in contact with the electrode body.

6. The heating carrier of claim 5, wherein the conductive paste contains a high-temperature paste formed of one or two or more pastes selected from a carbon paste containing silicate, a silver (Ag) paste, platinum (Pt), palladium (Pd), and indium tin oxide (ITO) pastes, an aluminum-doped zinc oxide (AZO) paste, a silicon carbide (SiC) paste, or a carbon paste.

7. An exhaust gas reduction carrier having a heating carrier, comprising:
a catalyst carrier installed in an accommodation space for a catalyst converter; and
a heating carrier including a main body of which the inside is formed to have a honeycomb structure, the main body being formed of a conductive ceramic material that is a nonmetallic heating element, and a catalyst layer formed by coating a first catalyst on a surface of the main body.

8. The exhaust gas reduction carrier having the heating carrier of claim 7, wherein the heating carrier is inserted into the center of the catalyst carrier to be concentric with the catalyst carrier, and has a diameter of 10% to 90% of a diameter of the catalyst carrier.

9. The exhaust gas reduction carrier having the heating carrier of claim 7, wherein the heating carrier is inserted into the catalyst carrier, and has a length of 10% to 90% of a length of the catalyst carrier.

10. The exhaust gas reduction carrier having the heating carrier of claim 7, wherein the heating carrier is inserted into the catalyst carrier, is formed to have a length longer than a length of the catalyst carrier, and penetrates through the catalyst carrier.

11. The exhaust gas reduction carrier having the heating carrier of claim 10, wherein the heating carrier further includes an electrode body wound around each of one end and the other end of the main body in a length direction.

12. The exhaust gas reduction carrier having the heating carrier of claim 11, wherein the heating carrier further includes a conductive paste coated on a surface of the electrode body and a point where the surface of the main body is in contact with the electrode body.

13. The exhaust gas reduction carrier having the heating carrier of claim 7, wherein the heating carrier includes:
a center carrier inserted into the center of the catalyst carrier to be concentric with the catalyst carrier; and
three or more peripheral carriers radially formed around the center carrier.
